(19) United States
(12) Patent Application Publication
(10) Pub. No.: US 2024/0351199 A1
(43) Pub. Date: Oct. 24, 2024

(54) METHOD AND APPARATUS FOR INTELLIGENTLY CONTROLLING MECHANICAL ARM

(71) Applicant: ZHENGZHOU UNIVERSITY OF LIGHT INDUSTRY, Zhengzhou (CN)

(72) Inventors: Hao LI, Zhengzhou (CN); Gen LIU, Zhengzhou (CN); Yonglei WU, Zhengzhou (CN); Haoqi WANG, Zhengzhou (CN); Linli LI, Zhengzhou (CN); Xiaoyu WEN, Zhengzhou (CN); Shizhong WEI, Zhengzhou (CN); Yuyan ZHANG, Zhengzhou (CN); Like ZHANG, Zhengzhou (CN); Weifei GUO, Zhengzhou (CN)

(73) Assignee: ZHENGZHOU UNIVERSITY OF LIGHT INDUSTRY, Zhengzhou (CN)

(21) Appl. No.: 18/739,773

(22) Filed: Jun. 11, 2024

(30) Foreign Application Priority Data
Apr. 22, 2023 (CN) 202410481057.1

(51) Int. Cl. B25J 9/16

(52) U.S. Cl. CPC B25J 9/163; B25J 9/1661

(57) ABSTRACT

A method for intelligently controlling a mechanical arm includes building a twin model of a mechanical arm, and extracting a state parameter and an action parameter corresponding to task characteristics from the twin model; determining a reward function corresponding to the task characteristics; training a twin delayed deep deterministic policy gradient (TD3) reinforcement learning model; simulating in the twin model based on a physical state parameter of the mechanical arm by using the TD3 reinforcement learning model, to obtain a controllable parameter; and controlling the mechanical arm to execute a corresponding task by using the controllable parameter. The TD3 reinforcement learning model is built based on the state parameter and the action parameter corresponding to the task characteristics and the reward function corresponding to the task characteristics, which can adapt to a dynamically changing environment and requirements for multiple tasks.

### CROSS-REFERENCE TO RELATED APPLICATIONS

This application claims priority to Chinese Patent Application No. 202410481057.1 with a filing date of Apr. 22, 2024. The content of the aforementioned application, including any intervening amendments thereto, is incorporated herein by reference.

### TECHNICAL FIELD

The present disclosure relates to the technical field of mechanical engineering, and in particular, to a method and apparatus for intelligently controlling a mechanical arm.

### BACKGROUND

With the advent of Industry 4.0, industrial automation and intelligent manufacturing have become important components of the manufacturing industry. The application of mechanical arms is becoming increasingly widespread, and requirements thereon especially in high-precision operations, complex tasks, and hazardous environmental operations are growing. With the rapid development of artificial intelligence, operations of the mechanical arms are no longer limited to simple repetitive tasks, but develop toward multiple tasks and complex tasks. However, conventional kinematic methods are often inadequate in the face of complex and changeable tasks, and cannot effectively adapt to a dynamically changing environment and meet requirements for multiple tasks.

### SUMMARY OF PRESENT INVENTION

The present disclosure provides a method and apparatus for intelligently controlling a mechanical arm, which can adapt to a dynamically changing environment and requirements for multiple tasks, and can complete tasks autonomously in a real-time complex and changeable environment.

To solve the above technical problems, a first technical solution of the present disclosure is as follows: A method for controlling a mechanical arm is provided, including: building a twin model of a mechanical arm, and extracting a state parameter and an action parameter corresponding to task characteristics from the twin model; determining a reward function corresponding to the task characteristics; training a twin delayed deep deterministic policy gradient (TD3) reinforcement learning model by using the state parameter, the action parameter, and the reward function; simulating in the twin model based on a physical state parameter of the mechanical arm by using the TD3 reinforcement learning model, to obtain a controllable parameter; and controlling the mechanical arm to execute a corresponding task by using the controllable parameter.

In a possible embodiment, the determining a reward function corresponding to the task characteristics includes: determining a task state function, a distance potential energy function, a collision penalty function, and a time penalty function, where the task state function denotes a completion status of a task; the distance potential energy function denotes a distance reward between a position of an end effector of the mechanical arm and a target position; the collision penalty function denotes a penalty function when the mechanical arm is subjected to an abnormal collision; the time penalty function denotes a penalty function when the mechanical arm fails to complete a task in each turn; determining a step-by-step reward function corresponding to the task characteristics based on the task state function, the distance potential energy function, the collision penalty function, and the time penalty function; and determining a total reward function of the task characteristics based on the step-by-step reward function corresponding to the task characteristics, where the total reward function of the task characteristics is a reward function corresponding to the task characteristics.

In a possible embodiment, the determining a distance potential energy function includes: calculating, based on position coordinates of the end effector of the mechanical arm and target position coordinates, an average coordinate value of the end effector of the mechanical arm and a target; and calculating the distance potential energy function based on the average coordinate value and a maximum distance by which the mechanical arm moves.

In a possible embodiment, the calculating, based on position coordinates of the end effector of the mechanical arm and target position coordinates, an average coordinate value of the end effector of the mechanical arm and a target includes:

$$distance = ( \frac{{\sum }_{i = 0}^{1} {( {x}_{i} - {x}_{goal} )}^{2} + {( {y}_{i} - {y}_{goal} )}^{2} + {( {z}_{i} - {z}_{goal} )}^{2}}{2} ) ,$$

where distance denotes the average coordinate value of the end effector of the mechanical arm and the target; (xᵢ, yᵢ, zᵢ) denotes the position coordinates of the end effector of the mechanical arm; i=1,2, which denotes a left claw and a right claw of the end effector of the mechanical arm; (x_{goal}, y_{goal}, z_{goal}) denotes the target position coordinates; and

the calculating the distance potential energy function based on the average coordinate value and a maximum distance by which the mechanical arm moves includes:

$${R}_{distance} = \frac{0.01}{{distance}_{max}} \times ( {distance}_{max} - distance ) ,$$

where R_{distance} denotes the distance potential energy function; and distanceₘₐₓ denotes the maximum distance by which the mechanical arm moves.

In a possible embodiment, the training a TD3 reinforcement learning model by using the state parameter, the action parameter, and the reward function includes: processing the reward function, the state parameter, and the action parameter by using an actor network based on the reinforcement learning model to obtain a maximum action meeting the reward function under the state parameter; and processing the action and the state parameter by using a critic network, so as to train the TD3 reinforcement learning model.

In a possible embodiment, the state parameter includes an angle of each axis of the mechanical arm, a task state, position coordinates of an end effector, and position coordinates of a target; and the action parameter includes the angle of each axis of the mechanical arm and/or an angle variation of each axis of the mechanical arm, and the angle variation denotes a variation of each axis of the mechanical arm from an initial angle to an angle of each axis for executing a task.

In a possible embodiment, before the simulating in the twin model based on a physical state parameter of the mechanical arm by using the TD3 reinforcement learning model, to obtain a controllable parameter, the method includes: transferring the TD3 reinforcement learning model to the twin model by using a transfer learning method.

In a possible embodiment, the physical state parameter of the mechanical arm includes an angle of each axis of the mechanical arm, position coordinates of a target, and a task state.

In a possible embodiment, the method further includes: updating the state parameter, the action parameter, and the reward function; and training the TD3 reinforcement learning model by using an updated state parameter, action parameter, and reward function, and performing the following step: simulating in the twin model based on a physical state parameter of the mechanical arm by using the TD3 reinforcement learning model, to obtain a controllable parameter.

To solve the above technical problems, a second technical solution of the present disclosure is as follows: An apparatus for controlling a mechanical arm is provided, including: a model building module, configured to build a twin model of a mechanical arm, and extract a state parameter and an action parameter corresponding to task characteristics from the twin model; a function establishing module, configured to determine a reward function corresponding to the task characteristics; a model training module, configured to train a TD3 reinforcement learning model by using the state parameter, the action parameter, and the reward function; a simulation module, configured to simulate in the twin model based on a physical state parameter of the mechanical arm by using the TD3 reinforcement learning model, to obtain a controllable parameter; and a control module, configured to control the mechanical arm to execute a corresponding task by using the controllable parameter.

Compared with the prior art, the present disclosure has the beneficial effects that the method for controlling a mechanical arm according to the present disclosure includes: building a twin model of a mechanical arm, and extracting a state parameter and an action parameter corresponding to task characteristics from the twin model; determining a reward function corresponding to the task characteristics; training a TD3 reinforcement learning model by using the state parameter, the action parameter, and the reward function; simulating in the twin model based on a physical state parameter of the mechanical arm by using the TD3 reinforcement learning model, to obtain a controllable parameter; and controlling the mechanical arm to execute a corresponding task by using the controllable parameter. According to the method, the TD3 reinforcement learning model is built based on the state parameter and the action parameter corresponding to the task characteristics and the reward function corresponding to the task characteristics, which can adapt to a dynamically changing environment and requirements for multiple tasks, can complete tasks autonomously in a real-time complex and changeable environment, and overcome the shortcomings of poor adaptability and flexibility of a conventional mechanical arm.

### BRIEF DESCRIPTION OF THE DRAWINGS

In order to describe the technical solutions in the embodiments of the present disclosure more clearly, the accompanying drawings required to describe the embodiments are briefly described below. Apparently, the accompanying drawings described below show only some embodiments of the present disclosure. Those of ordinary skill in the art may further obtain other accompanying drawings based on these accompanying drawings without creative efforts.

FIG. 1 is a schematic flowchart of a first embodiment of a method for controlling a mechanical arm according to the present disclosure;

FIG. 2 is a schematic flowchart of an embodiment of step S12 in FIG. 1; and

FIG. 3 is a schematic structural diagram of an embodiment of an apparatus for controlling a mechanical arm according to the present disclosure.

### DETAILED DESCRIPTION OF THE EMBODIMENTS

The technical solutions in the embodiments of the present application are clearly and completely described below with reference to the accompanying drawings in the embodiments of the present application. Apparently, the described embodiments are merely some rather than all of the embodiments of the present application. All other embodiments obtained by those of ordinary skill in the art based on the embodiments of the present application without any creative effort shall fall within the scope of protection of the present application.

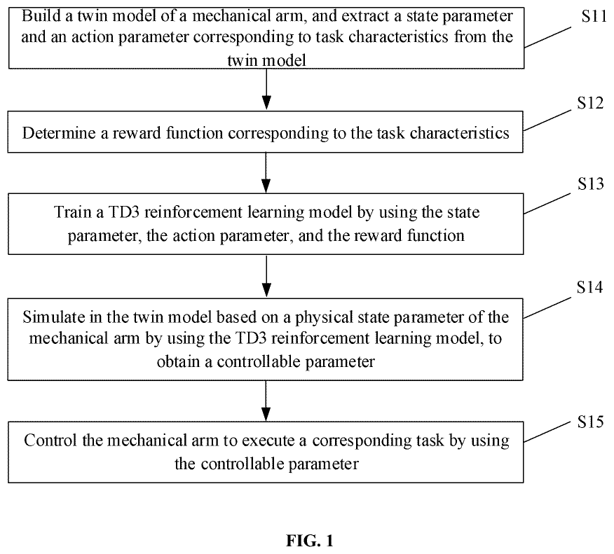

FIG. 1 is a schematic flowchart of a first embodiment of a method for controlling a mechanical arm according to the present disclosure. The method includes the following steps.

In step S11, a twin model of a mechanical arm is built, and a state parameter and an action parameter corresponding to task characteristics are extracted from the twin model.

Specifically, the corresponding twin model of the mechanical arm is built according to a physical system of the mechanical arm, and the state parameter and a controllable parameter are extracted from the twin model to describe and control an environmental state. The physical system of the mechanical arm includes a motor module of the mechanical arm, a raspberry pi module for controlling the mechanical arm, and a sensor module. On a simulation platform, the physical system of the mechanical arm and an environment around the mechanical arm are simulated by simulation software such as Unity3D, pybullet, and mujoco, and a virtual scene is constructed to obtain the twin model of the mechanical arm.

In a specific embodiment, a model is built based on the physical system of the mechanical arm by means of SolidWorks software, and then the model is transformed by a file conversion tool Blender. A transformed three-dimensional model is imported into the Unity3D simulation platform, and assembly is performed according to the imported three-dimensional model. A C #script is written for the movement of the mechanical arm. In addition, real-time data drive between Unity3D and raspberry pi and data communication between Unity3D and Python are built in Unity3D. Unity3D establishes bidirectional communication with the raspberry pi and Python via hypertext transfer protocol (HTTP) communication. Unity3D transmits a result of real-time simulation to Python, and Python learns an environment through deep reinforcement learning. In addition, Unity3D transmits an action to the raspberry pi, to control the movement of the mechanical arm, so as to obtain the twin model of the mechanical arm.

Task analysis is performed based on Markov decision, and the state parameter and the action parameter corresponding to the task characteristics are extracted. It can be understood that if a task is to open a valve, a state parameter and an action parameter corresponding to the task characteristics of opening the valve are extracted.

Markov decision is the basis of deep reinforcement learning, and can be used not only in a discrete action space, but also in [0, 1] and a continuous action space.

In step S12, a reward function corresponding to the task characteristics is determined.

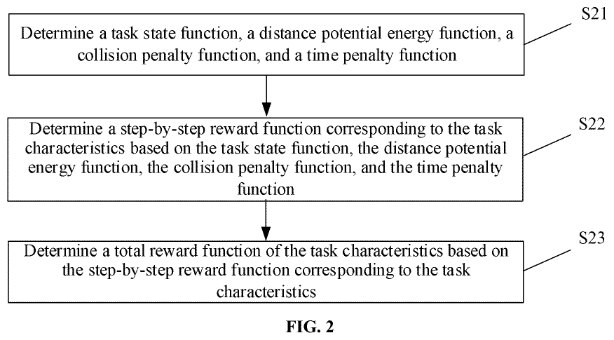

FIG. 2 is a schematic flowchart of an embodiment of step S12 in FIG. 1. Step S12 includes the following steps.

In step S21, a task state function, a distance potential energy function, a collision penalty function, and a time penalty function are determined.

Specifically, the task state function denotes a completion status of a task. The task state function may be sparse or dense, and then is normalized. A sparse design is simple, but an actual effect is not as good as that of a dense function. According to the present application, a dense reward function is used, which can help an algorithm to converge faster, and normalization is used for processing.

With an example in which the mechanical arm is used to open a valve, the valve rotates in an angle range of [0°, 90°], and a greater rotation angle indicates more rewards obtained. In a specific embodiment, a task state function of using the mechanical arm to open the valve is calculated as follows:

$${R}_{state} = \frac{angle}{90} ,$$

where Rₛₜₐₜₑ denotes the task state function, and angle denotes a valve rotation angle.

The distance potential energy function denotes a distance reward between a position of an end effector of the mechanical arm and a target position. Specifically, the position of the end effector of the mechanical arm is P_{end}=(xᵢ, yᵢ, zᵢ), and the target position thereof is P_{goal}=(x_{goal}, y_{goal}, z_{goal}). Normalization and weighting are performed based on the position and the target position of the end effector of the mechanical arm, so as to ensure a core position and attraction of a valve reward and avoid superseding what really counts.

Specifically, an average coordinate value of the end effector of the mechanical arm and a target is calculated based on position coordinates (xᵢ, yᵢ, zᵢ) of the end effector of the mechanical arm and target position coordinates (x_{goal}, y_{goal}, z_{goal}). Specifically,

$$distance = ( \frac{{\sum }_{i = 0}^{1} {( {x}_{i} - {x}_{goal} )}^{2} + {( {y}_{i} - {y}_{goal} )}^{2} + {( {z}_{i} - {z}_{goal} )}^{2}}{2} ) ,$$

where distance denotes the average coordinate value of the end effector of the mechanical arm and the target; (xᵢ, yᵢ, zᵢ) denotes the position coordinates of the end effector of the mechanical arm; i=1,2, which denotes a left claw and a right claw of the end effector of the mechanical arm; (x_{goal}, y_{goal}, z_{goal}) denotes the target position coordinates. It should be noted that during task execution, the mechanical arm moves in real time, and the position of the end effector of the mechanical arm changes in real time.

The distance potential energy function is calculated based on the average coordinate value and a maximum distance by which the mechanical arm moves. Specifically,

$${R}_{distance} = \frac{0.01}{{distance}_{max}} \times ( {distance}_{max} - distance ) ,$$

where R_{distance} denotes the distance potential energy function; and distanceₘₐₓ denotes the maximum distance by which the mechanical arm moves.

The collision penalty function R_{collision} denotes a penalty function when the mechanical arm is subjected to an abnormal collision. According to experience, the value is R_{collision}=−5.

The time penalty function Rₜᵢₘₑ denotes a penalty function when the mechanical arm fails to complete a task in each turn. According to experience, the value is Rₜᵢₘₑ=−0.1.

In step S22, a step-by-step reward function corresponding to the task characteristics is determined based on the task state function, the distance potential energy function, the collision penalty function, and the time penalty function.

In an embodiment, a step-by-step reward function corresponding to the task characteristics is:

$$Rt = {R}_{state} + {R}_{distance} + {R}_{collision} + {R}_{time} .$$

In step S23, a total reward function of the task characteristics is determined based on the step-by-step reward function corresponding to the task characteristics.

It should be noted that, during decision, the state parameter of the mechanical arm in a t moment state is sₜ, and an action parameter aₜ is executed according to a policy to enter a state parameter sₜ₊₁ of a next moment. In addition, a step-by-step reward function Rt of a current moment is obtained as a quad. (s, a, r, s′), s is a state parameter sₜ, and a is an action parameter aₜ. r is a step-by-step reward function Rt of a previous moment, and s′ is a state parameter sₜ₊₁ of the next moment. An optimal policy π(a|s) is searched for, to maximize the total reward function of the accumulated task characteristics. That is, the total reward function of the task characteristics is a reward function corresponding to the task characteristics. Specifically, the total reward function of the task characteristics is calculated as follows:

$$R = {\sum }_{t = 0}^{∞} {γ}^{t} Rt ,$$

where γ^{t} denotes a discount factor of a moment t, is in the range of [0,1], and is used to balance relative importance of an immediate reward and a future reward. Simply, the moment γ^{t} determines how much discount the algorithm will give to future time steps when calculating cumulative future rewards.

In step S13, a TD3 reinforcement learning model is trained by using the state parameter, the action parameter, and the reward function.

Specifically, the state parameter includes an angle of each axis of the mechanical arm, a task state such as an angle of a valve, position coordinates of an end effector, and position coordinates of a target such as a valve.

The action parameter includes the angle of each axis of the mechanical arm in a motion space and/or an angle variation of each axis of the mechanical arm, and the angle variation denotes a variation of each axis of the mechanical arm from an initial angle to an angle of each axis for executing a task.

In a specific embodiment, the TD3 reinforcement learning model is a combination of a TD3 model and a reinforcement learning (hindsight experience replay, HER) model. The TD3 model includes an actor network component and a critic network component. An actor network is responsible for learning a policy, and a critic network is responsible for learning a value function. The actor network updates the policy based on a feedback from the critic network. Since the critic network can provide more accurate gradient information, the TD3 reinforcement learning model is more stable in application.

In a specific embodiment, the actor network includes an input layer, a hidden layer, and an output layer. The input layer is configured to use a normalization technology to normalize input data, and the input layer has a size of 19, with an observation space in the form of a dictionary, including observation, achieved_goal, and desired_goal. Observation has a size of 7, including angles of six axes after normalization and an angle of a target such as a valve, which is in the range of [0,1]. achieved_goal refers to a current and reached state, with a size of 6, including a position P_{end}=(xᵢ, yᵢ, zᵢ) of the end effector of the mechanical arm. desired_goal refers to a desired target with a size of 6, including two target valve positions P_{goal}=(x_{goal}, y_{goal}, z_{goal}). Three-dimensional coordinate information of achieved_goal and desired_goal are normalized. The hidden layer of the actor network uses an intermediate layer with a width of 256, 512, 256, and a rectified linear unit (ReLU) activation function is used in the middle of the actor network to reduce a calculated amount. The output layer uses a tanh activation function behind the hidden layer, and the tanh activation function can map an output range to the range of [−1, 1]. The tanh formula is shown as follows.

$$tanh ( x ) = \frac{( {e}^{x} - {e}^{- x} )}{( {e}^{x} + {e}^{- x} )} .$$

The reward function, the state parameter, and the action parameter are processed by using the actor network based on the reinforcement learning model to obtain a maximum action meeting the reward function under the state parameter. In a specific embodiment, the actor network is triggered in every step of the TD3 algorithm, and a state parameter Sₜ is received. Sₜ is used as an input of the actor network. By means of the hidden layer, a vector in the range of [−1, 1] is finally output. Then the vector is scaled to the range of [−20, 20], and a corresponding action at is obtained by means of an original angle. The action at is a maximum action that meets the reward function under the state parameter Sₜ. Sprevious denotes angles of six axes of the mechanical arm at the previous moment, and outputs denotes an output result of the actor network. The formula of the action aₜ is as follows:

$${a}_{t} = {S}_{previous} + outputs \times 20.$$

I

The action and the state parameter are processed by using a critic network, so as to train the TD3 reinforcement learning model.

There are two critic networks in the TD3 algorithm, which are basically consistent with the actor network except the input layer and the output layer. The input layer of the critic is composed of a state parameter Sₜ and an output of the actor network, with a size of 25. The output layer is a specific value with a size of 1, and is used to calculate a value Q of the action aₜ under the state parameter Sₜ, and a smallest value Q of the two critics is taken to reduce an impact of network overestimation.

In addition, a target network is further added, and the adding of the target network can significantly improve stability of training. The target network includes the above-mentioned actor network and two critic networks. There are six neural networks in the TD3 algorithm: an actor network, a critic1 network, a critic2 network, a target actor network, a target critic1 network, and a target critic2 network.

The HER technology is a data enhancement technology for reinforcement learning, which resamples objects in a data buffer pool. According to experience of each sample, an agent will redefine a target and take the target as a training target. This target is usually a state achieved through experience, but not an initially set target state. HER also needs recalculation of a reward, and the reward is obtained based on achieved_goal and desired_goal of an observation space. The reward is the same as the distance potential energy function R_{distance} mentioned above.

Specifically, a training hyper-parameter is set according to the difficulty of a task, with a total step size set to 60 W, and a batch size set to 128. Ornstein-Uhlenbeck action noise is used as noise. The Ornstein-Uhlenbeck action noise is especially suitable for a scene where an action is a continuous value and is affected by random fluctuations, such as robot control. A noise level, sigma, is set to 0.3, which denotes a degree of exploration, but should not be too large, otherwise the convergence of the algorithm is affected.

After the hyper-parameter is set, training starts. The training process mainly includes interaction with an environment and network update. The environment refers to an environment in which the mechanical arm is located. First, the environment should be initialized. In this process, some necessary variables should be defined, such as definition of a state parameter, definition of an action parameter, initialization of two critic Q networks, two target Q networks, and initialization of Unity network communication. Then, a new turn is started. After the start of the turn, a state of an agent is initialized, a position of a valve is randomized, and the state parameter is input into the actor network, output and transformed. An action a is executed to obtain a reward rand a new state parameter s′, noise is added to the action a, and a˜π_{ϕ}(s)+ϵ, ϵ˜N(0, σ). Then (s, a, r, s′) is stored in the data buffer pool and the state parameter s′ is updated, and whether to update the network is determined based on a network update frequency. Then a convergence condition is checked to determine whether a specified number of steps is completed or whether an average reward meets requirements. After the convergence is met, the training is completed; otherwise, it is determined whether the mechanical arm has reached the maximum number of steps in the turn or has an abnormal time at which a collision or the like occurs. If the condition for the ending of the turn is met, a turn is restarted, and the above steps are repeated. If not, the action a is confirmed based on an output of the neural network actor under a current state parameter s, and the above steps are repeated.

In the network update of TD3, first, a batch of experiences (mini-batch) are randomly extracted from a buffer, and the following steps are performed for each experience.

Noise is added to an action in a state of s′, and ã←π_{ϕ′}(s′)+ϵ, ϵ˜clip (N (0,\tilde{σ}),−c, c);
a target Q value

$$y ← r + γ {min}_{i = 1 , 2} {Q}_{{θ}_{i}^{′}} ( {s}^{′} , \tilde{a} )$$

is calculated;
a critic network θᵢ←argmine_{θ}_{ᵢ}N⁻¹Σ(y−Q_{θ}_{ᵢ}(s, a))² is updated; and
the following steps are performed for every d step sizes:
the actor network is updated by using a deterministic policy gradient, ∇_{ϕ}J(ϕ)=N⁻¹Σ∇ₐQ_{θ}_{ᵢ}(s, a)|_{a=π}_{_{ϕ}}₍ₛ₎∇_{ϕ}π_{ϕ}(s), where J(ϕ) denotes a performance function of a policy, and measures a desired cumulative reward or performance under a policy π_{ϕ}. N denotes number or batch size of empirical samples. τ∇ₐQ_{θ}_{ᵢ}(s, a) denotes a gradient of a Q value function Q_{θ}_{ᵢ}(s, a) about an action a, and θ₁ denotes a parameter of the critic. π_{ϕ}(s) denotes an action generated by an actor network π in a given state s, and a parameter of the network is ϕ. ∇x denotes a gradient of x.

A target network is updated by using a soft update policy, and t denotes a factor of a soft update target network parameter.

$${θ}_{i}^{′} ← {τθ}_{i} + ( 1 - τ ) {θ}_{i}^{′} ; and$$

$${ϕ}^{′} ← τϕ + ( 1 - τ ) {ϕ}^{′} .$$

In step S14, simulation is performed in the twin model based on a physical state parameter of the mechanical arm by using the TD3 reinforcement learning model, to obtain a controllable parameter.

Specifically, the TD3 reinforcement learning model is transferred to the twin model by using a transfer learning method. Simulation is performed in the twin model based on the physical state parameter of the mechanical arm by using the TD3 reinforcement learning model, to obtain the controllable parameter.

Specifically, the physical state parameter of the mechanical arm includes an angle of each axis of the mechanical arm, position coordinates of a target, and a task state.

The physical state parameter of the mechanical arm is transmitted to the actor network in the TD3 algorithm, and then a vector with a length of 6 in the range of [−1,1] is output through forward propagation. An angle of an actual mechanical arm is obtained through linear transformation. The angle of the actual mechanical arm is imported into Unity3D (the TD3 reinforcement learning model is embedded in Unity3D) for simulation, and whether the mechanical arm is subjected to an abnormality such as collision or being stuck is detected for each frame. If no abnormality occurs, the information is synchronized to a raspberry pi system of the mechanical arm via HTTP, and then the movement of the mechanical arm is controlled. On the contrary, the information is pushed to a large screen of a factory through an interface and an alarm is initiated. After a worker receives a task, the alarm is eliminated and data is collected into a database.

In step S15, the mechanical arm is controlled to execute a corresponding task by using the controllable parameter.

Specifically, simulation is performed by means of step S14. If no abnormality occurs, the controllable parameter is synchronized to the raspberry pi system of the mechanical arm via HTTP, and then the movement of the mechanical arm is controlled.

Further, the state parameter, the action parameter, and the reward function are updated; and the TD3 reinforcement learning model is trained by using an updated state parameter, action parameter, and reward function, and the following step is performed: simulation is performed in the twin model based on a physical state parameter of the mechanical arm by using the TD3 reinforcement learning model, to obtain a controllable parameter. Specifically, since the simulation cannot completely replace a real environment, the mechanical arm in Unity3D is modified by means of data of a sensor in the physical system, and then this data is also stored in the database. If performance of a device drops obviously or at intervals, newer data in the database is trained as a training set by using the transfer learning method to achieve required performance.

According to the method for controlling a mechanical arm, the TD3 reinforcement learning model is built based on the state parameter and the action parameter corresponding to the task characteristics and the reward function corresponding to the task characteristics, which can adapt to a dynamically changing environment and requirements for multiple tasks, can complete tasks autonomously in a real-time complex and changeable environment, and overcome the shortcomings of poor adaptability and flexibility of a conventional mechanical arm.

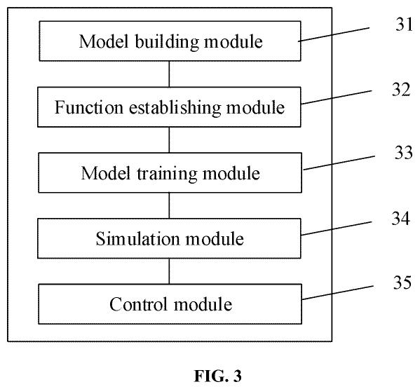

FIG. 3 is a schematic structural diagram of an embodiment of an apparatus for controlling a mechanical arm according to the present disclosure. The apparatus specifically includes a model building module 31, a function establishing module 32, a model training module 33, a simulation module 34, and a control module 35.

The model building module 31 is configured to build a twin model of a mechanical arm, and extract a state parameter and an action parameter corresponding to task characteristics from the twin model. The function establishing module 32 is configured to determine a reward function corresponding to the task characteristics. The model training module 33 is configured to train a TD3 reinforcement learning model by using the state parameter, the action parameter, and the reward function. The simulation module 34 is configured to simulate in the twin model based on a physical state parameter of the mechanical arm by using the TD3 reinforcement learning model, to obtain a controllable parameter. The control module 35 is configured to control the mechanical arm to execute a corresponding task by using the controllable parameter.

According to the apparatus for controlling a mechanical arm, the TD3 reinforcement learning model is built based on the state parameter and the action parameter corresponding to the task characteristics and the reward function corresponding to the task characteristics, which can adapt to a dynamically changing environment and requirements for multiple tasks, can complete tasks autonomously in a real-time complex and changeable environment, and overcome the shortcomings of poor adaptability and flexibility of a conventional mechanical arm.

The above is only the implementation method of the present disclosure, and is not intended to limit the patent scope of the present disclosure. Any equivalent structure or equivalent process transformation made by using the content of the specification and accompanying drawings of the present disclosure, which is directly or indirectly applied in other related technical fields, similarly falls within the patent protection scope of the present disclosure.

What is claimed is:

1. A method for controlling a mechanical arm, comprising:
building a twin model of a mechanical arm, and extracting a state parameter and an action parameter corresponding to task characteristics from the twin model;
determining a reward function corresponding to the task characteristics;
training a twin delayed deep deterministic policy gradient (TD3) reinforcement learning model by using the state parameter, the action parameter, and the reward function;
simulating in the twin model based on a physical state parameter of the mechanical arm by using the TD3 reinforcement learning model, to obtain a controllable parameter; and
controlling the mechanical arm to execute a corresponding task by using the controllable parameter.

2. The method according to claim 1, wherein the determining a reward function corresponding to the task characteristics comprises:
determining a task state function, a distance potential energy function, a collision penalty function, and a time penalty function, wherein the task state function denotes a completion status of a task; the distance potential energy function denotes a distance reward between a position of an end effector of the mechanical arm and a target position; the collision penalty function denotes a penalty function when the mechanical arm is subjected to an abnormal collision; and the time penalty function denotes a penalty function when the mechanical arm fails to complete a task in each turn;
determining a step-by-step reward function corresponding to the task characteristics based on the task state function, the distance potential energy function, the collision penalty function, and the time penalty function; and
determining a total reward function of the task characteristics based on the step-by-step reward function corresponding to the task characteristics, wherein the total reward function of the task characteristics is a reward function corresponding to the task characteristics.

3. The method according to claim 2, wherein the determining a distance potential energy function comprises:
calculating, based on position coordinates of the end effector of the mechanical arm and target position coordinates, an average coordinate value of the end effector of the mechanical arm and a target; and
calculating the distance potential energy function based on the average coordinate value and a maximum distance by which the mechanical arm moves.

4. The method according to claim 3, wherein the calculating, based on position coordinates of the end effector of the mechanical arm and target position coordinates, an average coordinate value of the end effector of the mechanical arm and a target comprises:
$$distance = ( \frac{{\sum }_{i = 0}^{1} {( {x}_{i} - {x}_{goal} )}^{2} + {( {y}_{i} - {y}_{goal} )}^{2} + {( {z}_{i} - {z}_{goal} )}^{2}}{2} ) ,$$
wherein distance denotes the average coordinate value of the end effector of the mechanical arm and the target; (xᵢ, yᵢ, zᵢ) denotes the position coordinates of the end effector of the mechanical arm; i=1,2, which denotes a left claw and a right claw of the end effector of the mechanical arm; (x_{goal}, y_{goal}, z_{goal}) denotes the target position coordinates; and
the calculating the distance potential energy function based on the average coordinate value and a maximum distance by which the mechanical arm moves comprises:
$${R}_{distance} = \frac{0.01}{{distance}_{max}} \times ( {distance}_{max} - distance ) ,$$
wherein R_{distance} denotes the distance potential energy function; and distanceₘₐₓ denotes the maximum distance by which the mechanical arm moves.

5. The method according to claim 1, wherein the training a TD3 reinforcement learning model by using the state parameter, the action parameter, and the reward function comprises:
processing the reward function, the state parameter, and the action parameter by using an actor network based on the reinforcement learning model to obtain a maximum action meeting the reward function under the state parameter; and
processing the action and the state parameter by using a critic network, so as to train the TD3 reinforcement learning model.

6. The method according to claim 1, wherein the state parameter comprises an angle of each axis of the mechanical arm, a task state, position coordinates of an end effector, and position coordinates of a target; and
the action parameter comprises the angle of each axis of the mechanical arm and/or an angle variation of each axis of the mechanical arm, and the angle variation denotes a variation of each axis of the mechanical arm from an initial angle to an angle of each axis for executing a task.

7. The method according to claim 5, wherein before the simulating in the twin model based on a physical state parameter of the mechanical arm by using the TD3 reinforcement learning model, to obtain a controllable parameter, the method comprises:
transferring the TD3 reinforcement learning model to the twin model by using a transfer learning method.

8. The method according to claim 5, wherein the physical state parameter of the mechanical arm comprises an angle of each axis of the mechanical arm, position coordinates of a target, and a task state.

9. The method according to claim 1, further comprising:
updating the state parameter, the action parameter, and the reward function; and
training the TD3 reinforcement learning model by using an updated state parameter, action parameter, and reward function, and performing the following step:
simulating in the twin model based on a physical state parameter of the mechanical arm by using the TD3 reinforcement learning model, to obtain a controllable parameter.

10. An apparatus for controlling a mechanical arm, comprising:
a model building module, configured to build a twin model of a mechanical arm, and extract a state parameter and an action parameter corresponding to task characteristics from the twin model;
a function establishing module, configured to determine a reward function corresponding to the task characteristics;
a model training module, configured to train a TD3 reinforcement learning model by using the state parameter, the action parameter, and the reward function;
a simulation module, configured to simulate in the twin model based on a physical state parameter of the mechanical arm by using the TD3 reinforcement learning model, to obtain a controllable parameter; and
a control module, configured to control the mechanical arm to execute a corresponding task by using the controllable parameter.
